(19) United States
(12) Patent Application Publication
(10) Pub. No.: US 2026/0012762 A1
(43) Pub. Date: Jan. 8, 2026

(54) Trigger-Based Data Ingestion for Machine Learning Using Edge Device

(71) Applicant: EdgeImpulse Inc., San Jose, CA (US)

(72) Inventors: Johannes Marinus Hendrikus Kamphuis, Ede (NL); Johannes Jongboom, Amsterdam (NL)

(73) Assignee: EdgeImpulse Inc., San Jose, CA (US)

(21) Appl. No.: 18/763,005

(22) Filed: Jul. 3, 2024

(51) Int. Cl. H04W 4/38

(52) U.S. Cl. CPC H04W 4/38

(57) ABSTRACT

An edge device comprising processing circuitry and memory stores a representation of a trigger condition. The edge device accesses streaming sensor data. The edge device determines, based on the streaming sensor data and using the processing circuitry, that the trigger condition is met. The edge device transmits the streaming sensor data to a computing device in response to determining that the trigger condition is met.

### TECHNICAL FIELD

Embodiments pertain to machine learning. Some embodiments relate to trigger-based data ingestion for machine learning inference technology.

### BACKGROUND

Machine learning inference technology may be performed with sensor data obtained from edge devices. However, in order to obtain relevant data, (e.g., data associated with certain conditions) a large amount of sensor data might need to be processed. This might not be possible with a resource-constrained (e.g., in terms of memory and power) edge device. Furthermore, processing the obtained data to determine if data of interest has been captured may be cumbersome. Techniques for optimizing the process of obtaining sensor data from the edge device may be desirable.

### BRIEF DESCRIPTION OF THE DRAWINGS

FIG. 1 illustrates the training and use of a machine-learning program, in accordance with some embodiments.

FIG. 2 illustrates an example neural network, in accordance with some embodiments.

FIG. 3 illustrates the training of an image recognition machine learning program, in accordance with some embodiments.

FIG. 4 illustrates a convolutional neural network, in accordance with some embodiments.

FIG. 5 is a block diagram of a computing machine, in accordance with some embodiments.

FIG. 6 illustrates an example hierarchy of machine learning classes, in accordance with some embodiments.

FIG. 7 illustrates an example convolution layer principle, in accordance with some embodiments.

FIG. 8 illustrates an example of an edge device, in accordance with some embodiments.

FIG. 9 illustrates an example of a computing device, in accordance with some embodiments.

FIG. 10 illustrates an example of a system for trigger-based data ingestion for machine learning, in accordance with some embodiments.

FIG. 11 is a flowchart of an example technique for trigger-based data ingestion for machine learning, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

As discussed above, techniques for optimizing the process of obtaining sensor data from an edge device may be desirable. An edge device may include a thin device with limited (e.g., compared to a server or a desktop computer) processing hardware, memory hardware, battery power, and/or network interface capabilities. For example, the edge device may have less than a threshold amount of processing hardware, memory hardware, battery power, and/or network interface capabilities. The edge device may be limited by a processing threshold, a memory threshold, a battery power threshold, and/or a network interface threshold. The processing threshold may include the processing hardware being a processing unit (e.g., a central processing unit (CPU)) with less than 1 gigahertz (GHz) clock speed or a limited number of cores (e.g., less than 4 cores). The memory threshold may include the memory hardware may having less 1 gigabyte (GB) of random-access memory (RAM) and/or less than 8 GB of storage. The battery power threshold may be the battery life being less than 4 hours under continuous operation. The network interface threshold may be the edge device having a maximum data transfer rate of less than 100 megabits per second (Mbps) or limited to 2.4 GHz Wi-Fi® connectivity. An edge device may be a single device or may include multiple devices. For example, an edge device may be a thin computer used to capture sensor data in the field in an agricultural, military, or similar setting. Alternatively, the edge device may be an Internet of Things (IoT) device installed in an appliance.

According to some implementations, an edge device that includes processing circuitry and memory stores a representation of a trigger condition for transmitting data. The trigger condition may be, for example, a temperature read by a temperature sensor exceeding 100 Celsius, a pressure read by a pressure sensor exceeding 800 millimeters of mercury (mmHg) or falling below 700 mmHg, a velocity exceeding 100 kilometers per hour, or the like. Alternatively, the trigger condition may be a mathematical function of the sensor data (e.g., a rate of change of the sensor data, a quotient of the pressure divided by the temperature, or the like). The edge device accesses streaming sensor data, for example, using sensor(s) connected to the edge device or included in the edge device. The edge device determines, based on the streaming sensor data, that the trigger condition is met, for example, by continuously reading the streaming sensor data and comparing the streaming sensor data to the trigger condition. Based on determining that the trigger condition is met, the edge device transmits the streaming sensor data to a computing device. The computing device may be a server, a desktop computer, or a laptop computer. The computing device may include multiple computing devices, for example, in a computing studio or a server farm.

Aspects of the present technology may be implemented as part of a computer system. The computer system may be one physical machine, or may be distributed among multiple physical machines, such as by role or function, or by process thread in the case of a cloud computing distributed model. In various embodiments, aspects of the technology may be configured to run in virtual machines that in turn are executed on one or more physical machines. It will be understood by persons of skill in the art that features of the technology may be realized by a variety of different suitable machine implementations.

The system includes various engines, each of which is constructed, programmed, configured, or otherwise adapted, to carry out a function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines comprise a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, each of which may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

As used herein, the term “model” encompasses its plain and ordinary meaning. A model may include, among other things, one or more engines which receive an input and compute an output based on the input. The output may be a classification. For example, an image file may be classified as depicting a cat or not depicting a cat. Alternatively, the image file may be assigned a numeric score indicating a likelihood whether the image file depicts the cat, and image files with a score exceeding a threshold (e.g., 0.9 or 0.95) may be determined to depict the cat.

This document may reference a specific number of things (e.g., “six mobile devices”). Unless explicitly set forth otherwise, the numbers provided are examples only and may be replaced with any positive integer, integer or real number, as would make sense for a given situation. For example, “six mobile devices” may, in alternative embodiments, include any positive integer number of mobile devices. Unless otherwise mentioned, an object referred to in singular form (e.g., “a computer” or “the computer”) may include one or multiple objects (e.g., “the computer” may refer to one or multiple computers).

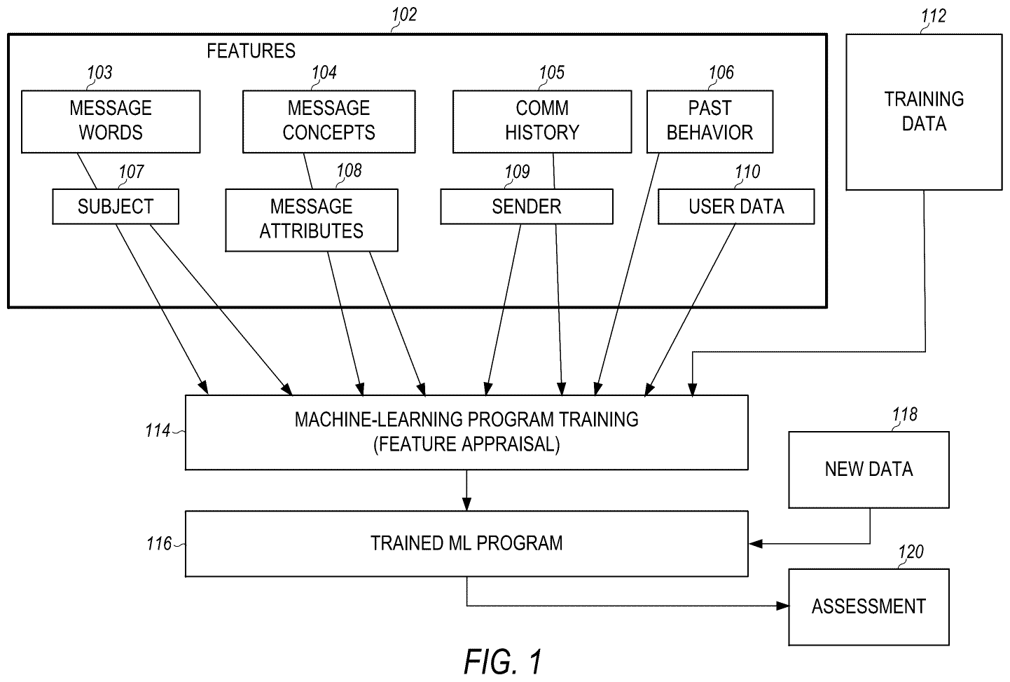

FIG. 1 illustrates the training and use of a machine-learning program, according to some example embodiments. In some example embodiments, machine-learning programs (MLPs), also referred to as machine-learning algorithms or tools, are utilized to perform operations associated with machine learning tasks, such as image recognition or machine translation.

Machine learning is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in machine learning, a computer could be provided with examples of images of elephants and be trained to determine which images have and lack depictions of elephants, without the programmer encoding explicit instructions as to how to identify an elephant. Machine learning explores the study and construction of algorithms, also referred to herein as tools, which may learn from existing data and make predictions about new data. Such machine-learning tools operate by building a model from example training data 112 in order to make data-driven predictions or decisions expressed as outputs or assessments 120. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange). Regression algorithms aim at quantifying some items (for example, by providing a value that is a real number). The machine-learning algorithms utilize the training data 112 to find correlations among identified features 102 that affect the outcome.

The machine-learning algorithms utilize features 102 for analyzing the data to generate assessments 120. A feature 102 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

In one example embodiment, the features 102 may be of different types and may include one or more of words of the message 103, message concepts 104, communication history 105, past user behavior 106, subject of the message 107, other message attributes 108, sender 109, and user data 110.

The machine-learning algorithms utilize the training data 112 to find correlations among the identified features 102 that affect the outcome or assessment 120. In some example embodiments, the training data 112 includes labeled data, which is known data for one or more identified features 102 and one or more outcomes, such as detecting communication patterns, detecting the meaning of the message, generating a summary of the message, detecting action items in the message, detecting urgency in the message, detecting a relationship of the user to the sender, calculating score attributes, calculating message scores, etc.

With the training data 112 and the identified features 102, the machine-learning tool is trained at operation 114. The machine-learning tool appraises the value of the features 102 as they correlate to the training data 112. The result of the training is the trained machine-learning program 116.

When the machine-learning program 116 is used to perform an assessment, new data 118 is provided as an input to the trained machine-learning program 116, and the machine-learning program 116 generates the assessment 120 as output. For example, when a message is checked for an action item, the machine-learning program utilizes the message content and message metadata to determine if there is a request for an action in the message.

Machine learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

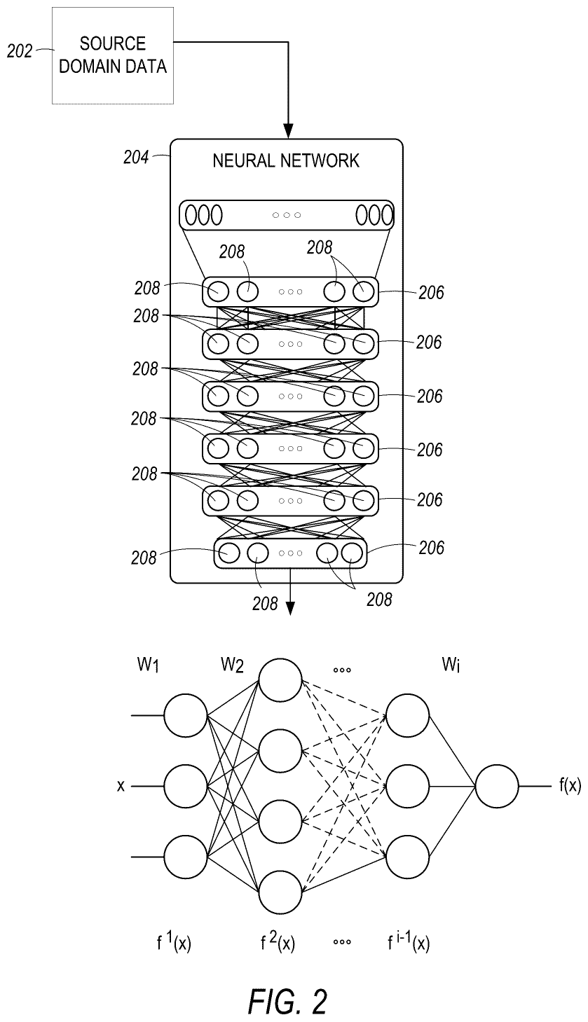

FIG. 2 illustrates an example neural network 204, in accordance with some embodiments. As shown, the neural network 204 receives, as input, source domain data 202. The input is passed through a plurality of layers 206 to arrive at an output. Each layer 206 includes multiple neurons 208. The neurons 208 receive input from neurons of a previous layer and apply weights to the values received from those neurons in order to generate a neuron output. The neuron outputs from the final layer 206 are combined to generate the output of the neural network 204.

As illustrated at the bottom of FIG. 2, the input is a vector x. The input is passed through multiple layers 206, where weights W₁, W₂, . . . , Wᵢ are applied to the input to each layer to arrive at f¹(x), f²(x), . . . , fⁱ⁻¹(x), until finally the output f(x) is computed.

In some example embodiments, the neural network 204 (e.g., deep learning, deep convolutional, or recurrent neural network) comprises a series of neurons 208, such as Long Short Term Memory (LSTM) nodes, arranged into a network. A neuron 208 is an architectural element used in data processing and artificial intelligence, particularly machine learning, which includes memory that may determine when to “remember” and when to “forget” values held in that memory based on the weights of inputs provided to the given neuron 208. Each of the neurons 208 used herein are configured to accept a predefined number of inputs from other neurons 208 in the neural network 204 to provide relational and sub-relational outputs for the content of the frames being analyzed. Individual neurons 208 may be chained together and/or organized into tree structures in various configurations of neural networks to provide interactions and relationship learning modeling for how each of the frames in an utterance are related to one another.

For example, an LSTM node serving as a neuron includes several gates to handle input vectors (e.g., phonemes from an utterance), a memory cell, and an output vector (e.g., contextual representation). The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., recognize units of speech). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

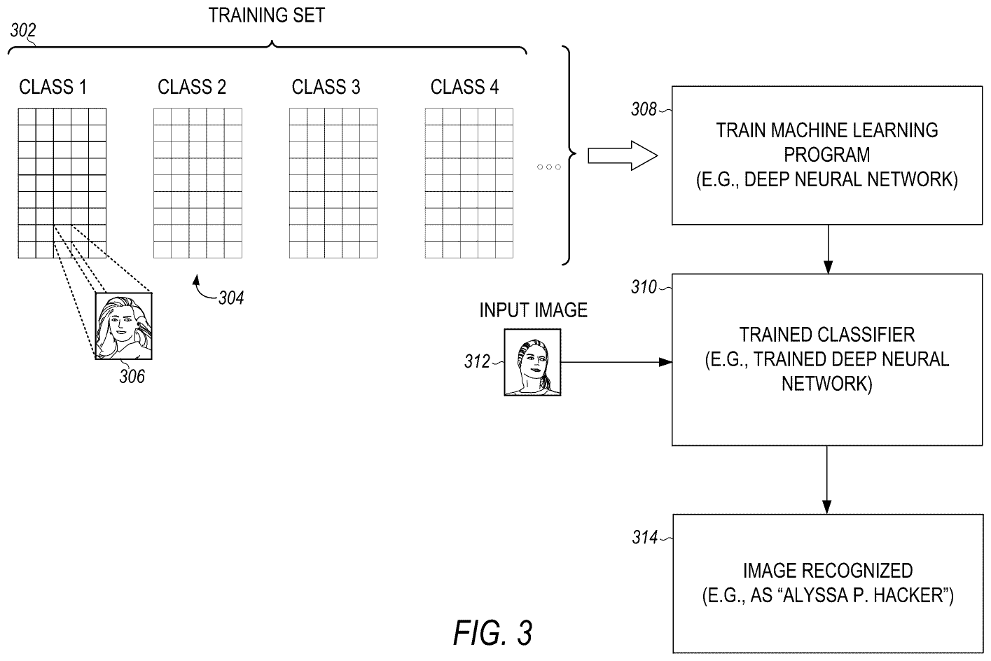

FIG. 3 illustrates the training of an image recognition machine learning program, in accordance with some embodiments. The machine learning program may be implemented at one or more computing machines. Block 302 illustrates a training set, which includes multiple classes 304. Each class 304 includes multiple images 306 associated with the class. Each class 304 may correspond to a type of object in the image 306 (e.g., a digit 0-9, a man or a woman, a cat or a dog, etc.). In one example, the machine learning program is trained to recognize images of various persons (i.e., to map a photograph of a person to the person's name), and each class 304 corresponds to each person, with each individual class 304 corresponding to an individual person (e.g., one class corresponds to Alyssa P. Hacker, one class corresponds to Ben Bitdiddle, etc.). At block 308 the machine learning program is trained, for example, using a deep neural network. At block 310, the trained classifier (e.g., the trained deep neural network), generated by the training of block 308, receives an input image 312, and at block 314 the image is recognized. For example, if the image 312 is a photograph of Alyssa P. Hacker, the classifier recognizes the image as corresponding to Alyssa P. Hacker at block 314. The classifier may include a DNN, as illustrated by the circle with the circular arrows.

FIG. 3 illustrates the training of a classifier, according to some example embodiments. A machine learning algorithm is designed for recognizing faces, and a training set 302 includes data that maps a sample to a class 304 (e.g., a class includes all the images of purses). The classes may also be referred to as labels. Although implementations presented herein are presented with reference to object recognition, the same principles may be applied to train machine-learning programs used for recognizing any type of items.

The training set 302 includes a plurality of images 306 for each class 304 (e.g., image 306), and each image is associated with one of the categories to be recognized (e.g., a class). The machine learning program is trained 308 with the training data to generate a classifier 310 operable to recognize images. In some example embodiments, the machine learning program is a DNN.

When an input image 312 is to be recognized, the classifier 310 analyzes the input image 312 to identify the class (e.g., class 314) corresponding to the input image 312.

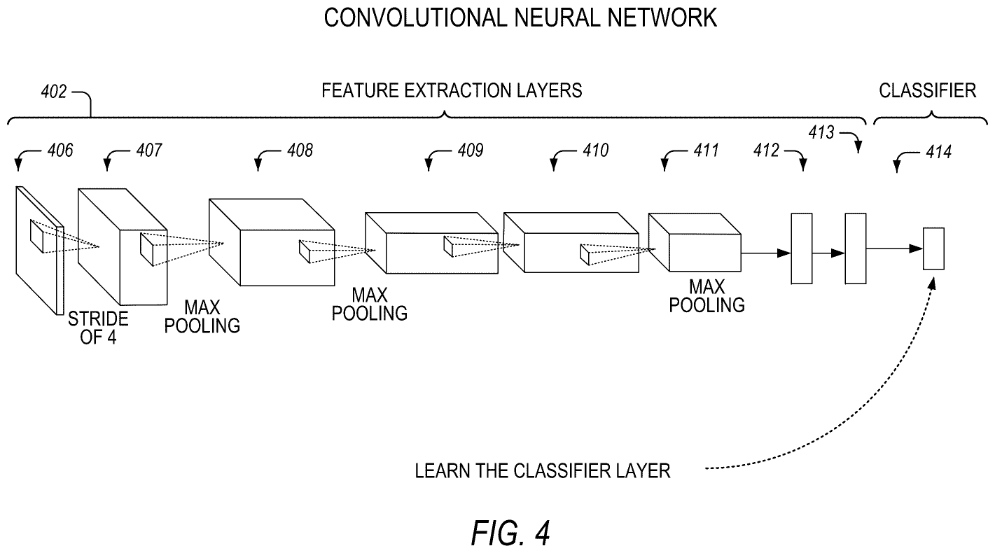

FIG. 4 illustrates a convolutional neural network, according to some example embodiments. Training a classifier of the convolutional neural network may be accomplished with feature extraction layers 402 and classifier layer 414. Each image is analyzed in sequence by a plurality of layers 406-413 in the feature-extraction layers 402.

With the development of deep convolutional neural networks, the focus in face recognition has been to learn a good face embedding-based classifier, in which faces of the same person are close to each other, and faces of different persons are far away from each other. For example, the verification task with the LFW (Labeled Faces in the Wild) dataset has been often used for face verification.

Many face identification tasks (e.g., MegaFace and LFW) are based on a similarity comparison between the images in the gallery set and the query set, which is essentially a K-nearest-neighborhood (KNN) method to estimate the person's identity. In the ideal case, there is a good face feature extractor (inter-class distance is always larger than the intra-class distance), and the KNN method is adequate to estimate the person's identity.

Feature extraction is a process to reduce the amount of resources required to describe a large set of data. When performing analysis of complex data, one of the major problems stems from the number of variables involved. Analysis with a large number of variables generally requires a large amount of memory and computational power, and it may cause a classification algorithm to overfit to training samples and generalize poorly to new samples. Feature extraction is a general term describing methods of constructing combinations of variables to get around these large data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with very sparse data) to smaller vectors capturing the same, or similar, amount of information.

Determining a subset of the initial features is called feature selection. The selected features are expected to contain the relevant information from the input data, so that the desired task can be performed by using this reduced representation instead of the complete initial data. DNN utilizes a stack of layers, where each layer performs a function. For example, the layer could be a convolution, a non-linear transform, the calculation of an average, etc. Eventually this DNN produces outputs by classifier 414. In FIG. 4, the data travels from left to right and the features are extracted. The goal of training the neural network is to find the parameters of all the layers that make them adequate for the desired task.

As shown in FIG. 4, a “stride of 4” filter is applied at layer 406, and max pooling is applied at layers 407-413. The stride controls how the filter convolves around the input volume. “Stride of 4” refers to the filter convolving around the input volume four units at a time. Max pooling refers to down-sampling by selecting the maximum value in each max pooled region.

In some example embodiments, the structure of each layer is predefined. For example, a convolution layer may contain small convolution kernels and their respective convolution parameters, and a summation layer may calculate the sum, or the weighted sum, of two pixels of the input image. Training assists in defining the weight coefficients for the summation.

One way to improve the performance of DNNs is to identify newer structures for the feature-extraction layers, and another way is by improving the way the parameters are identified at the different layers for accomplishing a desired task. The challenge is that for a typical neural network, there may be millions of parameters to be optimized. Trying to optimize all these parameters from scratch may take hours, days, or even weeks, depending on the amount of computing resources available and the amount of data in the training set.

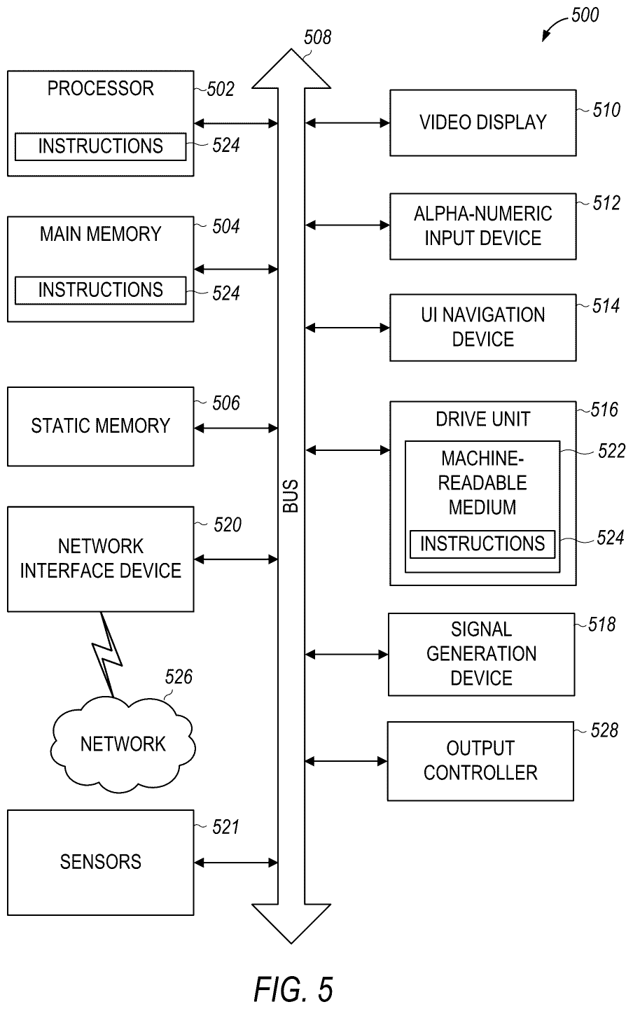

FIG. 5 illustrates a circuit block diagram of a computing machine 500 in accordance with some embodiments. In some embodiments, components of the computing machine 500 may store or be integrated into other components shown in the circuit block diagram of FIG. 5. For example, portions of the computing machine 500 may reside in the processor 502 and may be referred to as “processing circuitry.” Processing circuitry may include processing hardware, for example, one or more central processing units (CPUs), one or more graphics processing units (GPUs), and the like. In alternative embodiments, the computing machine 500 may operate as a standalone device or may be connected (e.g., networked) to other computers. In a networked deployment, the computing machine 500 may operate in the capacity of a server, a client, or both in server-client network environments. In an example, the computing machine 500 may act as a peer machine in peer-to-peer (P2P) (or other distributed) network environment. In this document, the phrases P2P, device-to-device (D2D) and sidelink may be used interchangeably. The computing machine 500 may be a specialized computer, a personal computer (PC), a tablet PC, a personal digital assistant (PDA), a mobile telephone, a smart phone, a web appliance, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems/apparatus (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The computing machine 500 may include a hardware processor 502 (e.g., a central processing unit (CPU), a GPU, a hardware processor core, or any combination thereof), a main memory 504 and a static memory 506, some or all of which may communicate with each other via an interlink (e.g., bus) 508. Although not shown, the main memory 504 may contain any or all of removable storage and non-removable storage, volatile memory or non-volatile memory. The computing machine 500 may further include a video display unit 510 (or other display unit), an alphanumeric input device 512 (e.g., a keyboard), and a user interface (UI) navigation device 514 (e.g., a mouse). In an example, the display unit 510, input device 512 and UI navigation device 514 may be a touch screen display. The computing machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The computing machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The drive unit 516 (e.g., a storage device) may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the computing machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the computing machine 500 and that cause the computing machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526.

Energy consumption is a crucial consideration in edge computing, particularly in the context of edge machine learning (ML). Edge ML refers to the practice of running machine learning models on edge devices, which are typically closer to the source of data generation compared to cloud-based computing.

While the focus in the development of conventional ML models has traditionally been on accuracy and speed, energy efficiency becomes of utmost importance with ML models being deployed on edge devices, often times operating on battery power.

Energy efficiency is especially problematic in the context of tiny ML-a subset of edge ML, specifically targeting the most constrained devices such as microcontrollers or other embedded systems, which have very limited computational, memory, and energy resources.

Tiny ML models are designed to be highly efficient and compact, with optimized algorithms and architectures that can run locally on such devices. These models are typically trained on a larger host machine and then flashed to the constrained target device, where they are used for inference.

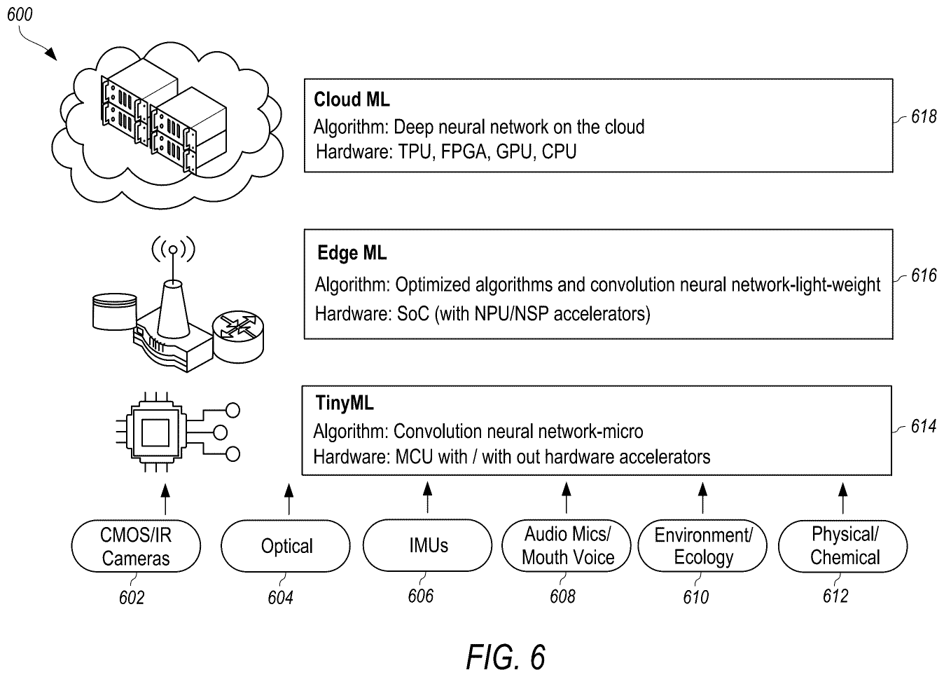

FIG. 6 illustrates an example hierarchy 600 of ML classes. As shown, Complementary metal-oxide semiconductor (CMOS)/infrared (IR) cameras 602, optical 604, inertial measurement units (IMUs) 606, audio microphones (mics)/mouth voice 608, environment/ecology 610, and physical/chemical 612 sensors feed to tiny ML 614. Edge ML 616 is more advanced or complex than tiny ML 614. Cloud ML 618 is more advanced or complex than edge ML 616. Tiny ML 615, edge ML 616, and cloud ML 618 receive input from the sensors 602-612. Tiny ML 614 uses the algorithm of convolutional neural network and hardware of microcontroller unit (MCU) with or without hardware accelerators. Edge ML 616 uses optimized algorithms and convolutional neural networks (e.g., light-weight) and hardware of system on a chip (SoC) with neural processing unit (NPU)/neural signal processor (NSP) accelerators. Cloud ML 618 uses the algorithm of deep neural network on the cloud and hardware of tensor processing unit (TPU), field-programmable gate array (FPGA), graphics processing unit (GPU), and/or central processing unit (CPU).

Some implementations are related to an inference energy estimation framework for edge ML 616 devices. Some implementations estimate energy consumption of tiny ML 614 models inference on constrained edge devices given the architecture of the model and a type of device as inputs. Some implementations may assist in enabling developers to create and deploy machine learning models on small, low-power devices such as microcontrollers and sensors.

Some schemes leverage performance monitor counters (PMCs) and/or simulations to determine energy use of ML models executing on edge devices. Some disadvantages of these schemes include that PMCs do not provide per-processor results and simulations may utilize significant time overhead.

ML includes, among other things, building models to enable computers to “learn” from data. Different ML techniques and model types are applied to either classification tasks, where the ML model classifies an input sample into one of predefined categories, or regression tasks, where a model predicts or estimates a continuous value based on one or more input values.

A convolutional neural network (CNN) is a ML model that is used to extract features (like edges, shapes) from input images to classify them in one of categories. CNNs consist of different types of layers, mainly convolutional layers (e.g., pointwise convolution, depthwise convolution) and activation layers.

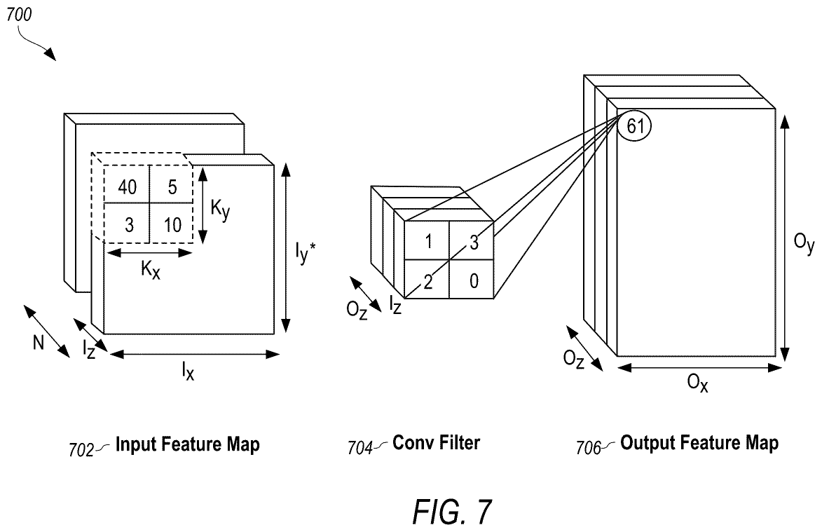

FIG. 7 illustrates an example convolution layer principle 700. As shown, an input feature map 702 is passed through a convolutional (conv) filter 704 to obtain an output feature map 706.

Training and inference are two distinct phases in the life cycle of a machine learning model.

During the training phase, a machine learning model learns patterns and features from a labeled dataset. This involves adjusting the model's parameters through iterative optimization techniques to minimize the difference between predicted outputs and actual labels. Training typically uses a larger amount of computational resources and time compared to inference.

The inference phase involves applying the trained model to new, unseen data to make predictions or classifications. This phase may use less computational power compared to training and is often executed on devices with constrained resources, such as edge devices. More lightweight frameworks, which are typically subsets of training frameworks, are used for running inference on devices. Inference might, in some cases, not leverage operating system support, any standard C or C++ libraries, or dynamic memory allocation.

In the context of CNNs, training involves updating the weights of convolutional and other layers using backpropagation and gradient descent methods. Inference, however, consists of passing new data through the trained layers to obtain predictions without modifying the model's parameters.

Edge ML introduces a set of unique challenges and considerations that differentiate it from traditional machine learning paradigms.

Edge ML has limited resources. Machine learning algorithms that are efficient on traditional systems might not directly translate to embedded platforms due to computational resource constraints. The development of novel optimization techniques that strike a balance between model complexity and resource utilization may be useful.

In deployment and maintenance, unlike traditional setups where models can be updated centrally, edge devices might be deployed in remote or inaccessible locations. This introduces challenges related to model deployment, updates, and maintenance. Over-the-air updates, model version control, and adaptive learning techniques are useful in ensuring the models stay relevant and performant over time.

Turning to energy efficiency, machine learning algorithms optimized solely for accuracy might not be suitable in context of a battery-powered device, as they could drain the device's energy reserves rapidly. Developing energy-efficient algorithms that balance accuracy with power consumption is essential. Some implementations attempt to tackle this constraint by providing embedded ML engineers with a faster way to reason about an energy budget of the application they are developing.

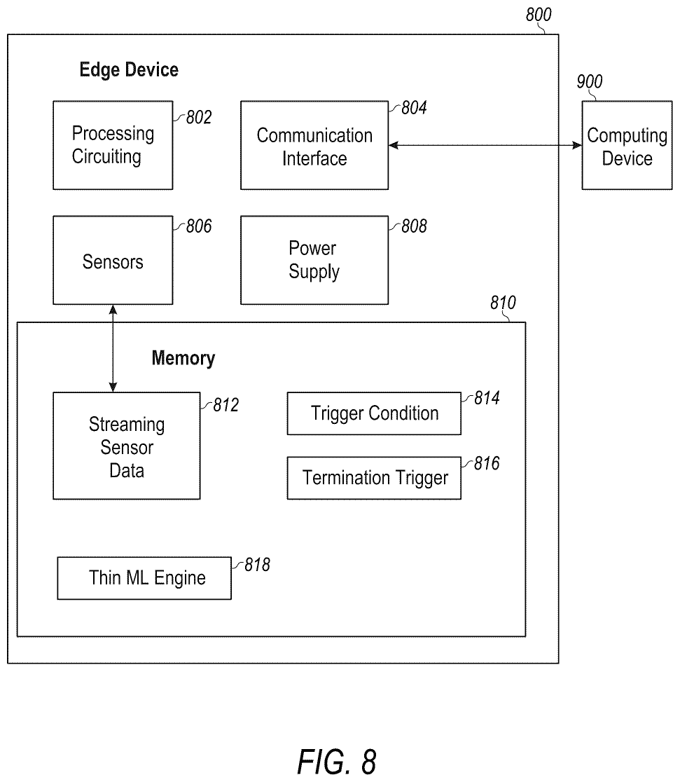

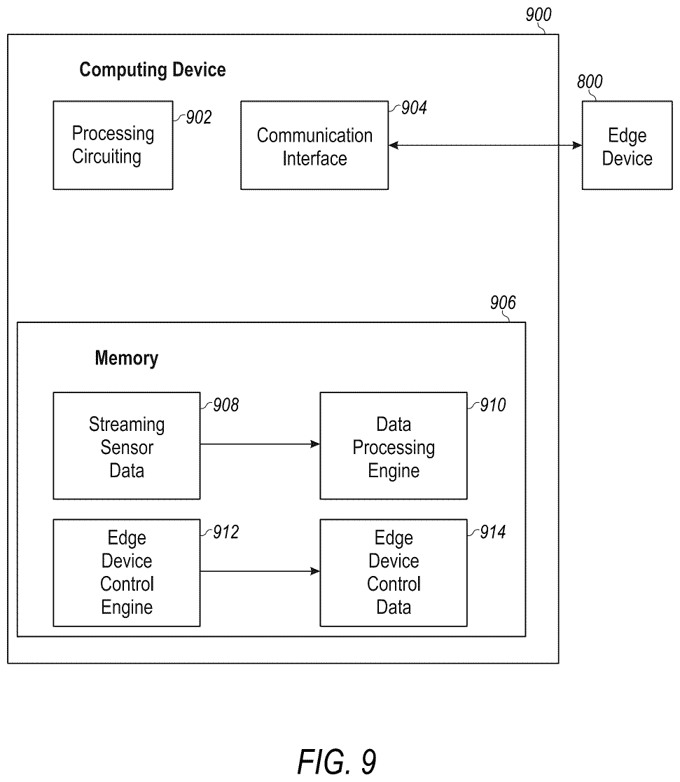

FIG. 8 illustrates an example of an edge device 800, in accordance with some embodiments. As shown, the edge device 800 includes processing circuitry 802, a communication interface 804, sensors 806, a power supply 808, and memory 810. The edge device 800 may include all or a portion of the components of the computing machine 500. The processing circuitry 802 may correspond to the processor 502. The communication interface 804 may correspond to the network interface device 520 and may be used for communication over the network 526. Alternatively or in addition, the communication interface 804 may correspond to a wired connection or a direct radio (e.g., Bluetooth®) connection. As shown, the communication interface 804 is used to communicate with a computing device 900, which is described in greater detail in conjunction with FIG. 9.

The sensors 806 may correspond to the sensors 521. The sensors 806 may include at least one of a temperature sensor, a heat sensor, a pressure sensor, a light sensor, an ultraviolet or infrared sensor, a sound sensor, an ultrasound sensor, a radar or LIDAR (light detection and ranging) sensor, a motion sensor, or the like. While multiple sensors 806 are described, the disclosed technology may be implemented with a single sensor. The sensors 806 may be components of the edge device 800, as shown. Alternatively, the sensors 806 may be connected to the edge device 800 via at least one of a wired connection, a wireless (e.g., Bluetooth®, Wi-Fi® or near field communication (NFC)) connection, or a network connection. The sensors 806 detect streaming sensor data 812 (e.g., environmental data of an environment surrounding the edge device 800) and transmit the streaming sensor data 812 to the memory 810 for storage or processing.

The memory 810 may correspond to at least one of the main memory 504, the static memory 506, or the drive unit 516. As illustrated, the memory 810 stores the streaming sensor data 812, a trigger condition 814, a termination trigger 816, and a thin ML engine 818. As described above, the streaming sensor data 812 is received from the sensors 806 and may be briefly stored in the memory 810 for processing. The trigger condition 814 may be received from the computing device 900 and indicates a trigger for initiating transmission of at least a portion of the streaming sensor data 812 to the computing device 900. The termination trigger 816 may be received from the computing device 900 and indicates a trigger for terminating the transmission of the portion of the streaming sensor data 812 to the computing device 900.

The thin ML engine 818 may be a CNN or may implement other ML technology. The thin ML engine 818 allows for some ML processing of the streaming sensor data 812 (e.g., anomaly detection) to be performed at the edge device 800. In some cases, the output of the thin ML engine 818 may correspond to the trigger condition 814 or the termination trigger 816, or the trigger condition or the termination trigger 816 may be based on values calculated by the thin ML engine 818. The thin ML engine 818 may be obtained, by the edge device 800, from the computing device 900.

According to some implementations, the edge device 800 stores the trigger condition 814 in the memory 810 of the edge device 800. The edge device 800 accesses streaming sensor data 812 using at least one of the sensors 806. The edge device 800 determines, based on the streaming sensor data 812, that the trigger condition 814 is met. The edge device 800 transmits, using the communication interface 804, the streaming sensor data 812 to the computing device 900 based on determining that the trigger condition 814 is met.

In some cases, the trigger condition 814 includes a value determined based on the streaming sensor data 812 passing (e.g., exceeding or falling below) a predefined threshold. The value may correspond to the streaming sensor data 812 (e.g., the temperature going below 0 Celsius or going above 100 Celsius) or may correspond to a mathematical function of the streaming sensor data 812 (e.g., the pressure in mmHg divided by the temperature in Kelvin being within a numeric range). In some cases, the trigger condition is based on a change in value determined based on the streaming sensor data 812 (e.g., the temperature rising or falling at a rate exceeding 2 Celsius degrees per minute, where the streaming sensor data 812 includes the temperature but not its rate of change).

In some cases, the trigger condition is based on the streaming sensor data itself and/or a value determined based on the streaming sensor data being in an anomaly range. The anomaly range may be identified by the thin ML engine 818. For example, the thin ML engine 818 may apply statistical and/or CNN techniques to determine the anomaly range. Alternatively, the anomaly range may be received, via the communication interface 804, from the computing device 900. The anomaly range may be manually determined by a user of the computing device 900 or may be determined by statistical or artificial intelligence techniques implemented at the computing device 900 and/or another computing device.

In some cases, the thin ML engine 818 is a classification engine that executes at the edge device 800. The trigger condition 814 is based on a classifier result determined based on the streaming sensor data 812. In some cases, the edge device 800 receives a representation of a set of classifier results associated with the trigger condition 814 from the computing device 900.

In some cases, the trigger condition 814 includes a value from the streaming sensor data 812 entering a range (e.g., the temperature exceeding 100 Celsius). In some cases, the trigger condition 814 is based on a classifier result (e.g., calculated by the thin ML engine 818) determined based on the streaming sensor data 812. In some cases, the trigger condition 814 is based on an average, a root mean square, or a moving average of values in the streaming sensor data 812 received during a predetermined period of time preceding a current time.

As illustrated, the termination trigger 816 is stored at the edge device 800. The edge device terminates transmission of the streaming sensor data in response to determining that the termination trigger 816 is met. The termination trigger 816 may correspond to the streaming sensor data 812 and/or be determined based on the streaming sensor data 816, similarly to the trigger condition 814. Alternatively, the termination trigger 816 may correspond to a receipt of a termination signal from the computing device 900 or another machine. In some cases, the termination trigger 816 corresponds to the battery power of the power supply 808 of the edge device 800 falling below a threshold level. Some implementations might not involve the edge device 800 storing the termination trigger 816. The edge device 800 may use other techniques to determine when to terminate transmission of the streaming sensor data 812. For example, the streaming sensor data 812 may be transmitted for a predetermined time period (e.g., two minutes) after occurrence of the trigger condition 812.

FIG. 9 illustrates an example of the computing device 900, in accordance with some embodiments. While the computing device 900 is illustrates as a single device. The computing device 900 may include multiple devices (e.g., a studio of devices or a server farm). The computing device 900 may include one or more of a server, a laptop computer, or a desktop computer. As shown, the computing device 900 includes processing circuitry 902, a communication interface 904, and a memory 906. The computing device 900 may include all or a portion of the components of the computing machine 500. The processing circuitry 902 may correspond to the processor 502. The communication interface 904 may correspond to the network interface device 520 and may be used for communication over the network 526. Alternatively or in addition, the communication interface 904 may correspond to a wired connection or a direct radio (e.g., Bluetooth®) connection. As shown, the communication interface 904 is used to communicate with the edge device 800.

The memory 906 may correspond to at least one of the main memory 504, the static memory 506, or the drive unit 516. As shown, the memory 906 stores streaming sensor data 908. The streaming sensor data 908 may correspond to a portion of the streaming sensor data 812 that is transmitted from the edge device 800 to the computing device 900. The portion of the streaming sensor data 812 that is transmitted from the edge device 800 to the computing device 900 may be determined, by the edge device 800, using the techniques described herein.

As illustrated, the streaming sensor data 908 is provided to a data processing engine 910. The data processing engine 910 may be an artificial intelligence engine and may include at least one of a statistical engine, a CNN, a large language model (LLM), a generative pretrained transformer (GPT), or other artificial intelligence or data processing technology. The data processing engine 910 obtains intelligence from the streaming sensor data 908 and provides the obtained intelligence to human users or other computing machines for further analysis or action taking. The human users may receive the obtained intelligence in a visual output (e.g., via a graphical user interface) or in a message transmitted to an address (e.g., an email address or other messaging address). The message may be written in a natural language (e.g., English, Spanish, or Japanese) using at least one of the LLM or the GPT.

As shown, the memory 906 includes an edge device control engine 912. The edge device control engine 912 determines one or more edge device control data 914 for transmission to the edge device 800 via the communication interface 904. The edge device control data 914 may include at least one of the trigger condition 814, the termination trigger 816, the thin ML engine 818, or values for operation of the thin ML engine 818. In some cases, the edge device control engine 912 is an artificial intelligence engine that automatically determines the edge device control data 914 (e.g., based on stored data about the edge device 800 or the environment in which the edge device 800 is operating). Alternatively, the edge device control data 914 may be determined directly by human input or based on a human input. For example, the human input may correspond to a sensitivity value (e.g., indicating relative tolerance for false negative and false positive results), and thresholds for the trigger condition 814 or the termination trigger 816 may be determined based on the sensitivity value.

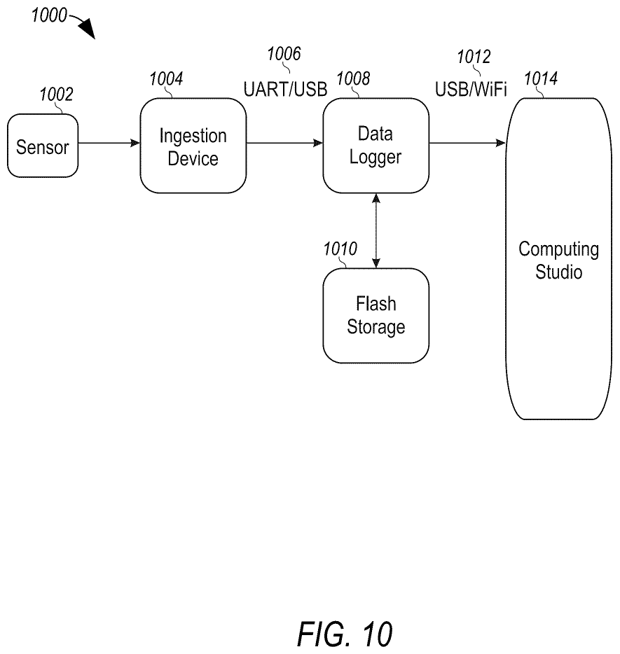

FIG. 10 illustrates an example of a system 1000 for trigger-based data ingestion for machine learning, in accordance with some embodiments. The system 1000 may be used for data logging, data transmission, and/or data processing, as described herein.

As shown, the system 1000 includes a sensor 1002 that provides streaming sensor data (e.g., the streaming sensor data 812) to an ingestion device 1004. The sensor 1002 may be one or more of the sensors 806. The ingestion device 1004 may correspond to the edge device 800. As shown, the ingestion device 1004 has a universal asynchronous receiver-transmitter (UART) or universal serial bus (USB) connection 1006 to a data logger 1008. The data logger 1008 transmits the received sensor data to flash storage 1010. The data logger 1008 transmits the received sensor data, via a USB or Wi-Fi® connection 1012, to a computing studio 1014.

The computing device 900 may correspond to one or more of the data logger 1008, the flash storage 1010, or the computing studio 1014. Alternatively, the data logger 1008 may be a component of the edge device 800. In some cases, the ingestion device 1004 is in a remote location (e.g., in an agricultural field or in a rarely visited location (e.g., deep sea or Antarctica) being studied by scientists). Thus, the data logger 1008 is used to obtain data from the ingestion device 1004 and to transmit the data to the flash storage 1010 and/or to the computing studio 1014. In some cases, the data logger 1008 is a mobile phone (or other portable computing device) that is occasionally taken to the remote location to communicate with the ingestion device 1004. In some cases, the data logger 1008 is a special-purpose data logging device that is not a mobile phone and that is capable of communication with the ingestion device 1004 via the UART or USB connection 1006.

In some cases, users of edge devices (e.g., the ingestion device 1004 or the edge device 800) do not use ingestion tools for data capturing. Instead, such users may create custom tools and load sensor data using a comma separated value (CSV) uploader. It may be difficult to sample data from a device that is not physically connected to a laptop computer or desktop computer doing the sampling.

In some cases, the data logger 1008 may have battery power and wireless connectivity. In some cases, the data logger 1008 may have high data throughput, being capable of high-speed USB data transmission. In some cases, the data logger 1008 is capable of sampling over a long period of time (e.g., a time period longer than a threshold, for example, longer than one hour, longer than two hours, longer than one day, longer than two days, or the like) without being connected to the computing studio 1012. The data logger 1008 may be equipped with the flash storage 1010 having sufficient free space for the sampling over the long period of time.

In some cases, the flash storage 1010 is a removable storage medium (e.g., a USB flash drive) that may be disconnected from the data logger 1010 and connected to a device of the computing studio 1014. In some cases, the data logger 1008 starts and/or stops logging data based on a control signal received from the computing studio 1014. Alternatively, the starting and/or stopping of logging data may be done without connectivity (e.g., by a human user pushing a button of the data logger 1008).

If the ingestion device 1004 is not capable of storing data, the data logger 1008 may be used to store data obtained by the ingestion device 1004. The data logger 1008 may communicate with the ingestion device 1004 to obtain sensor data and to provide the sensor data to the computing studio 1014. The data logger 1008 acts as a USB host or connects over UART to the ingestion device 1004. The ingestion device 1004 outputs the sensor data in a specialized format for capturing and storing by the data logger 1008.

The data logger 1008 may store the sampling data in a specialized format (e.g., concise binary object representation (CBOR) format) as a file on an secure digital (SD) card or on the flash storage 1010. Upon connection with the computing studio 1014, the data logger may communicate with the computing studio 1014 to synchronize the sampled data.

Capture relevant data from the sensor 1002 can take up hours of running ingestion. This may unnecessarily take up resources (e.g., memory or power). Furthermore, a human user might have to review the data and find out if data of interest is captured.

Using a threshold trigger, some implementations start capturing sampled data when the signal passes a pre-defined threshold. This works on time series data. An averaged value of the axis with the highest output value may be used for the trigger. Averaging can be done using Root Mean Square (RMS), or another technique. The threshold may be configurable in the computing studio 1014.

Using a data change trigger, instead of threshold value that needs to be reached before the sampling start, the start of sampling may be triggered by a change of value of any of the axes. A hysteresis value may be configured to determine the minimal step size.

Using an anomaly trigger, some implementations use the inference pipeline (which might not be used during ingestion) to trigger sampling. This way, some implementations can capture relevant data with same power and memory budget. A user first creates a model with known (idle) data and an anomaly learning block. This model is deployed on the ingestion device 1004. From the computing studio 1014, the user may select an anomaly trigger using a user interface for controlling the ingestion (e.g., an ingestion tab). This user interface may allow the user to enable sampling if the anomaly score is higher than a preconfigured value. In some cases, the anomaly score may be based on a visual anomaly determined by a CNN (e.g., of the thin ML engine 818).

The classifier trigger operates similarly to the anomaly trigger but uses classifier results (e.g., obtained by the thin ML engine 818) instead. The score threshold and/or the label of the category of interest may be configured by users of the computing studio 1014.

Some implementations relate to configuring a trigger to start and/or stop data ingestion. The trigger may be at least one of a threshold trigger, an anomaly trigger, or a classifier trigger. The threshold trigger may be the RMS level being above (or below) a certain threshold or being within at least one range. This triggers sampling to start. Sampling stops when the RMS falls below (or above) the threshold or leaves the at least one range. The anomaly trigger allows the user to select the anomaly threshold via the computing studio 1014. The classifier trigger causes sampling to start if a certain class is detected by a classifier (e.g., the thin ML engine 818). The label and/or the threshold for the classifier are set in the computing studio 1014.

In some cases, available trigger options may be presented to a user of the computing studio 1014 via a dropdown menu, a set of radio buttons, or another graphical user interface element. In some cases, at least one of the anomaly trigger, the threshold trigger, or the classifier trigger might not be available.

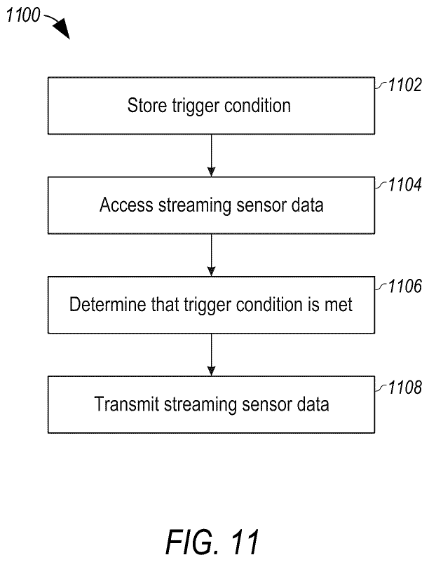

FIG. 11 is a flowchart of an example technique 1100 for trigger-based data ingestion for machine learning, in accordance with some embodiments. The technique 1100 may be preformed by an edge device (e.g., the edge device 800).

At block 1102, the edge device stores a representation of a trigger condition (e.g., the trigger condition 814). The trigger condition may include least one of the anomaly trigger, the threshold trigger, or the classifier trigger.

At block 1104, the edge device accesses streaming sensor data (e.g., the streaming sensor data 812). The streaming sensor data may be received from sensors of the edge device or sensors connected to the edge device. The sensors may correspond to the sensors 806 and/or the sensor 1002.

At block 1106, the edge device determines, based on the streaming sensor data, that the trigger condition is met. For example, the edge device may continuously or periodically compare the streaming sensor data (or a calculation based on the streaming sensor data) to the trigger condition to determine if the trigger condition is met.

At block 1108, the edge device transmits the streaming sensor data to a computing device (e.g., the computing device 900, the ingestion device 1004, the flash 1010, or the computing studio 1014) in response to determining that the trigger condition is met. The transmitted streaming sensor data may be displayed as a graphical output at the computing device and/or further processed at the computing device using more complex models than those available at the edge device.

Some embodiments are described as numbered examples (Example 1, 2, 3, etc.). These are provided as examples only and do not limit the technology disclosed herein.
Example 1 is a method comprising: storing a representation of a trigger condition at an edge device comprising processing circuitry and memory; accessing streaming sensor data at the edge device; determining, based on the streaming sensor data and using the processing circuitry of the edge device, that the trigger condition is met; and transmitting the streaming sensor data from the edge device to a computing device in response to determining that the trigger condition is met.
In Example 2, the subject matter of Example 1 includes, wherein the trigger condition comprises a value determined based on the streaming sensor data passing a predefined threshold.
In Example 3, the subject matter of Examples 1-2 includes, wherein the trigger condition is based on a change in a value determined based on the streaming sensor data.
In Example 4, the subject matter of Examples 1-3 includes, wherein the trigger condition is based on a value determined based on the streaming sensor data being in an anomaly range, wherein the anomaly range is identified by a thin machine learning engine executing at the edge device.
In Example 5, the subject matter of Example 4 includes, receiving, from the computing device, a representation of the anomaly range.
In Example 6, the subject matter of Examples 1-5 includes, wherein the trigger condition is based on a classifier result determined based on the streaming sensor data, wherein the classifier result is determined by a thin classification engine executing at the edge device.
In Example 7, the subject matter of Example 6 includes, receiving, from the computing device, a representation of a set of classifier results associated with the trigger condition.
In Example 8, the subject matter of Examples 1-7 includes, wherein the trigger condition is based on an average, a root mean square, or a moving average of values in the streaming sensor data received during a predetermined period of time preceding a current time.
In Example 9, the subject matter of Examples 1-8 includes, storing a termination trigger condition at the edge device; terminating transmission of the streaming sensor data in response to determining that the termination trigger condition is met.
In Example 10, the subject matter of Examples 1-9 includes, wherein the streaming sensor data is transmitted for a predetermined time period.
In Example 11, the subject matter of Examples 1-10 includes, wherein a memory capacity of the memory of the edge device is below a threshold memory capacity.
In Example 12, the subject matter of Examples 1-11 includes, wherein a processing capacity of the processing circuitry of the edge device is below a threshold processing capacity.
Example 13 is a non-transitory computer-readable medium storing instructions operable to cause an edge device to perform operations comprising: storing a representation of a trigger condition at the edge device comprising processing circuitry and memory; accessing streaming sensor data at the edge device; determining, based on the streaming sensor data and using the processing circuitry of the edge device, that the trigger condition is met; and transmitting the streaming sensor data from the edge device to a computing device in response to determining that the trigger condition is met.
In Example 14, the subject matter of Example 13 includes, wherein the trigger condition comprises a value determined based on the streaming sensor data passing a predefined threshold.
In Example 15, the subject matter of Examples 13-14 includes, wherein the trigger condition is based on a change in a value determined based on the streaming sensor data.
In Example 16, the subject matter of Examples 13-15 includes, wherein the trigger condition is based on a value determined based on the streaming sensor data being in an anomaly range, wherein the anomaly range is identified by a thin machine learning engine executing at the edge device.
In Example 17, the subject matter of Example 16 includes, the operations further comprising: receiving, from the computing device, a representation of the anomaly range.
Example 18 is an edge device comprising: memory storing instructions; and processing circuitry configured to execute the instructions to perform operations comprising: storing a representation of a trigger condition at the edge device; accessing streaming sensor data at the edge device; determining, based on the streaming sensor data and using the processing circuitry of the edge device, that the trigger condition is met; and transmitting the streaming sensor data from the edge device to a computing device in response to determining that the trigger condition is met.
In Example 19, the subject matter of Example 18 includes, wherein the trigger condition comprises a value determined based on the streaming sensor data passing a predefined threshold.
In Example 20, the subject matter of Examples 18-19 includes, wherein the trigger condition is based on a change in a value determined based on the streaming sensor data.
Example 21 is at least one machine-readable medium including instructions that, when executed by processing circuitry, cause the processing circuitry to perform operations to implement of any of Examples 1-20.
Example 22 is an apparatus comprising means to implement of any of Examples 1-20.
Example 23 is a system to implement of any of Examples 1-20.
Example 24 is a method to implement of any of Examples 1-20.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory” or “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry. The memory subsystem may include a single memory unit or multiple joint or disjoint memory units, which each of the multiple joint or disjoint memory units storing all or a portion of the data described as being stored in the memory subsystem.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

As used herein, the term “and/or” encompasses its plain and ordinary meaning and may refer to an intersection or a union of sets of data. For example, the phrase “A and/or B” encompasses the union of A and B. The phrase “A and/or B” encompasses the intersection of A and B. The phrase “A and/or B” encompasses at least one of A or at least one of B. The phrase “A and/or B” may encompass A alone, B alone, or A and B together.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
storing a representation of a trigger condition at an edge device comprising processing circuitry and memory;
accessing streaming sensor data at the edge device;
determining, based on the streaming sensor data and using the processing circuitry of the edge device, that the trigger condition is met; and
transmitting the streaming sensor data from the edge device to a computing device in response to determining that the trigger condition is met.

2. The method of claim 1, wherein the trigger condition comprises a value determined based on the streaming sensor data passing a predefined threshold.

3. The method of claim 1, wherein the trigger condition is based on a change in a value determined based on the streaming sensor data.

4. The method of claim 1, wherein the trigger condition is based on a value determined based on the streaming sensor data being in an anomaly range, wherein the anomaly range is identified by a thin machine learning engine executing at the edge device.

5. The method of claim 4, further comprising:
receiving, from the computing device, a representation of the anomaly range.

6. The method of claim 1, wherein the trigger condition is based on a classifier result determined based on the streaming sensor data, wherein the classifier result is determined by a thin classification engine executing at the edge device.

7. The method of claim 6, further comprising:
receiving, from the computing device, a representation of a set of classifier results associated with the trigger condition.

8. The method of claim 1, wherein the trigger condition is based on an average, a root mean square, or a moving average of values in the streaming sensor data received during a predetermined period of time preceding a current time.

9. The method of claim 1, further comprising:
storing a termination trigger condition at the edge device;
terminating transmission of the streaming sensor data in response to determining that the termination trigger condition is met.

10. The method of claim 1, wherein the streaming sensor data is transmitted for a predetermined time period.

11. The method of claim 1, wherein a memory capacity of the memory of the edge device is below a threshold memory capacity.

12. The method of claim 1, wherein a processing capacity of the processing circuitry of the edge device is below a threshold processing capacity.

13. A non-transitory computer-readable medium storing instructions operable to cause an edge device to perform operations comprising:
storing a representation of a trigger condition at the edge device comprising processing circuitry and memory;
accessing streaming sensor data at the edge device;
determining, based on the streaming sensor data and using the processing circuitry of the edge device, that the trigger condition is met; and
transmitting the streaming sensor data from the edge device to a computing device in response to determining that the trigger condition is met.

14. The non-transitory computer-readable medium of claim 13, wherein the trigger condition comprises a value determined based on the streaming sensor data passing a predefined threshold.

15. The non-transitory computer-readable medium of claim 13, wherein the trigger condition is based on a change in a value determined based on the streaming sensor data.

16. The non-transitory computer-readable medium of claim 13, wherein the trigger condition is based on a value determined based on the streaming sensor data being in an anomaly range, wherein the anomaly range is identified by a thin machine learning engine executing at the edge device.

17. The non-transitory computer-readable medium of claim 16, the operations further comprising:
receiving, from the computing device, a representation of the anomaly range.

18. An edge device comprising:
memory storing instructions; and
processing circuitry configured to execute the instructions to perform operations comprising:
storing a representation of a trigger condition at the edge device;
accessing streaming sensor data at the edge device;
determining, based on the streaming sensor data and using the processing circuitry of the edge device, that the trigger condition is met; and
transmitting the streaming sensor data from the edge device to a computing device in response to determining that the trigger condition is met.

19. The edge device of claim 18, wherein the trigger condition comprises a value determined based on the streaming sensor data passing a predefined threshold.

20. The edge device of claim 18, wherein the trigger condition is based on a change in a value determined based on the streaming sensor data.
